(19) United States
(12) Patent Application Publication
(10) Pub. No.: US 2004/0182214 A1
(43) Pub. Date: Sep. 23, 2004

(54) Handling arrangement for sawing items

(76) Inventors: Guy Courtois, Freiburg (DE); Werner Jager, Rheinhausen (DE); Klaus Schopp, Freiburg (DE); Bernhard Wurth, Kappel-Grafenhausen (DE)

Correspondence Address: CHRISTIE, PARKER & HALE, LLP, PO BOX 7068, PASADENA, CA, 91109-7068, US

(21) Appl. No.: 10/477,774

(22) PCT Filed: May 17, 2002
(86) PCT No.: PCT/DE02/01893

(30) Foreign Application Priority Data
May 17, 2001 (DE) 201 08 813.4

(51) Int. Cl. B26D 5/00

(52) U.S. Cl. 83/365

(57) ABSTRACT

The invention relates to a handling arrangement for sawing items, especially for charging a multi-bladed disc saw. Said arrangement is characterised by means of automatic spatial orientation of at least one sawing item, especially plank shaped items, on a sawing device, which enables particularly simple and efficient handling to take place.

The invention relates to a handling apparatus for items to be sawn, as claimed in the precharacterizing clause of claim 1.

Feeding items to be sawn to wood saws represents a problem since the item to be sawn is in the form of a natural product with an irregular shape, so that it is difficult to align it with the sawing apparatus.

For conventional processing using a saw, one or two operators is or are therefore used, who assesses or assess the curvature of the item to be sawn, feed it to the sawing apparatus, and remove and stack the cut planks.

The original item to be sawn in the case of the sawing apparatuses under consideration here are in the form, for example, of solid wood boards which may or may not have been trimmed in which case, in principle, any items from the range of solid pieces of wood may be sawn up.

The present invention is based on the object of providing an apparatus to simplify the handling of the item to be sawn.

According to the invention, this object is achieved by a handling apparatus for items to be sawn having the features of claim 1.

The processing of the item to be sawn is considerably simplified and speeded up by the use of a means for automatic three-dimensional alignment of at least one item to be sawn, in particular a board, with respect to a sawing apparatus. This allows, for example, boards which have not been trimmed to be aligned automatically with respect to the zero line of a sawing apparatus.

In one advantageous embodiment of the handling apparatus for items to be sawn, this zero line can be determined automatically. In order to avoid complicated guidance paths for the item to be sawn, the zero line of the item to be sawn is made to match the zero line of the associated circular saw blade.

It is advantageous to automatically detect not only the zero line of the item to be sawn but also its external contour, such as the timber edge or other curvatures, and/or unevennesses.

An apparatus for distance measurement is particularly suitable for detection of such unevennesses, allowing the respective distance from the apparatus to the item to be sawn to be determined from a defined point. Measurements such as these may likewise be carried out by means of light barriers, however. The contours are in this case determined as a function of the respective light barrier sensors through which the item to be sawn in each case passes. Particularly accurate measurement results are obtained with a combination of both apparatuses.

One preferred embodiment of the apparatus for distance measurement is a laser rangefinder, which produces particularly accurate measurement results.

For precise positioning of the item to be sawn, it is advantageous not only to determine the unevennesses of one edge of the item to be sawn in the horizontal direction but also its unevennesses in the vertical direction. This produces a very precise representation of the contour of the item to be sawn. Measurements such as these are preferably carried out using the laser rangefinder.

In order to detect the shape of the item to be sawn more quickly, it is advantageous to use two or more apparatuses for distance measurement.

With regard to the processing of the measurement data from the distance measurement, it is advantageous to use a camera or a laser scanner, or the two combined, for data acquisition in at least one measurement data acquisition area.

The camera is in this case preferably arranged above the item to be sawn. Since the stack height of the item to be sawn is flexible by virtue of the production process, the camera height can be adjusted automatically with respect to the item to be sawn. The distance between the camera and the item to be sawn is thus constant, in this way avoiding the creation of distorted images in the camera.

In order to process the measurement data, it is advantageous to couple the camera to a data processing apparatus in which, for example, the board curvature and/or the zero line of the item to be sawn can be calculated.

If the measurement data is determined by means of a camera and laser scanner, it is worthwhile arranging the laser scanner transversely with respect to the main extent direction of the item to be sawn. The light lines of the scanner thus produce a type of light grating transversely with respect to the boards or with respect to the stack of the item to be sawn.

The measurement values which are determined by the camera scanning this light grating represent the basis for calculation of the contour of the item to be sawn. The contour data which is calculated in the data processing apparatus is preferably stored in a memory, where it can be called up by other assemblies in the handling apparatus.

In order to keep the sawing residue that is produced as small as possible, the item to be sawn is preferably automatically aligned with the zero line of the item to be sawn by means of an alignment means, once its zero line has been calculated.

It is particularly advantageous to use a robot for this purpose, with a gripper for holding the item to be sawn, which positions its gripper as a function of the data stored in the memory.

This arrangement ensures a very fast production process.

Further advantageous refinements of the invention are described in the dependent claims.

The invention will be explained in more detail in the following text using an exemplary embodiment and with reference to the figures of the drawings, in which:

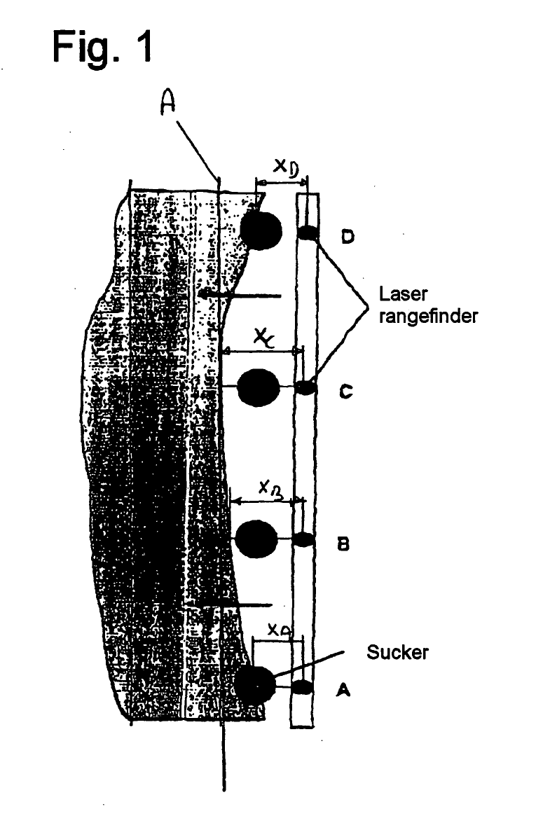

FIG. 1 shows an outline sketch of the method of operation of one embodiment according to the invention; and

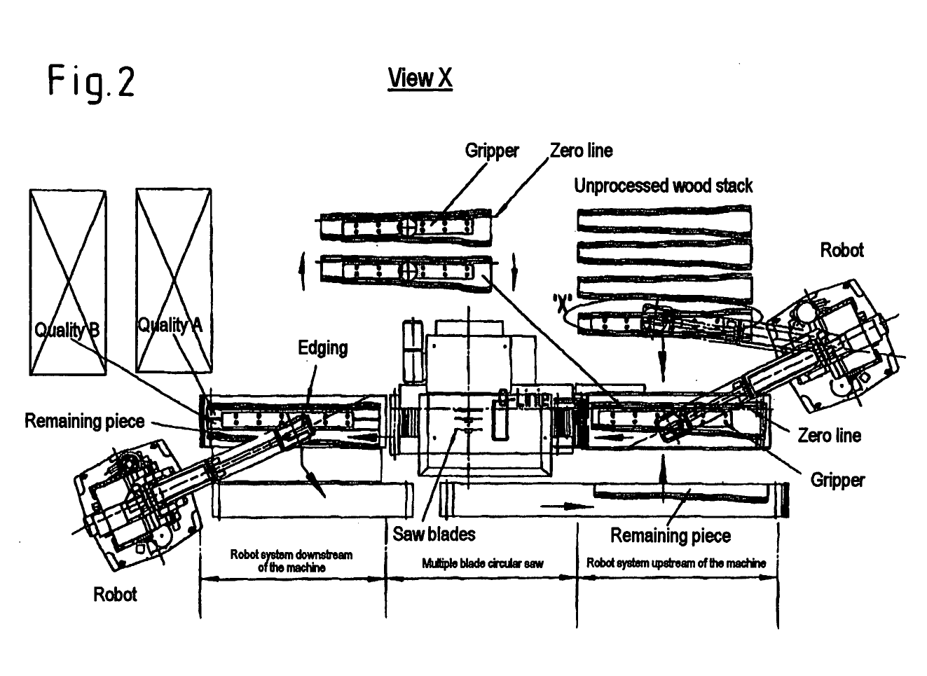

FIG. 2 shows a schematic plan view of one embodiment according to the invention.

An untrimmed piece of wood with a timber edge is shown as the item to be sawn on the left in FIG. 1. This item to be sawn is intended to be cut up into individual planks by means of a sawing apparatus which is not illustrated here. Alternatively, untrimmed boards can also be processed, which, for example, are curved after the drying process.

Vacuum suckers, illustrated here in the form of large circles, ensure that the item to be sawn is held. Since the surface of the item to be sawn is uneven, the suckers must be sufficiently elastic and must also be capable of being aligned automatically in three dimensions. Alternatively, other means for holding and positioning the item to be sawn are also possible, such as mechanical apparatuses.

Four laser rangefinders A, B, C, D are shown on the right in FIG. 1, and are arranged on a gripper of a robot. These laser rangefinders can detect the position of the timber edge in various ways.

In a first variant, the lateral distances X_{A}, X_{B}, X_{C}, X_{D} from the timber edge of the item to be sawn are measured. The complex shape of the timber edge is recorded by means of a series of polygons from the distance measurements. The tangent to this series of polygons would then represent the zero line of the item to be sawn. A safety margin can also be used for the choice of the zero line, since the series of polygons cannot completely map the timber edge.

A means for automatic three-dimensional alignment of at least one item to be sawn, in particular a board, uses these distance measurements to ensure that the item to be sawn is aligned with respect to a saw blade. In the process, an alignment means (for example a computer-controlled gripper) ensures that the section line A of the saw blade is chosen such that the minimum amount of sawing residue is produced. The sawing residue is located to the right of the section line A in the illustrated situation.

The item to be sawn is aligned fully automatically by means of a first computer-controlled robot, which is not shown here.

In a second alternative, the gripper is moved together with the laser rangefinders in the direction of the arrows toward the item to be sawn, and the laser rangefinders are pointed vertically at the item to be sawn. As soon as the gripper makes contact with the timber edge (recorded, for example, by means of the laser rangefinder A), it rotates about this point until a second laser beam makes contact with the item to be sawn (for example the laser rangefinder D). As soon as this has occurred, the gripper moves over the item to be sawn parallel to the line defined in this way, until all the remaining laser rangefinders have made contact with the item to be sawn. In this case, the laser rangefinders act as a type of light barrier.

In a third alternative, the laser rangefinders are likewise used as a type of light barrier. The gripper together with the laser rangefinders is moved in the direction of the arrows towards the item to be sawn. As soon as all the laser rangefinders have made contact with the item to be sawn, the zero line is determined.

The use of robots makes it possible, for example, to operate a sawing apparatus such as a multiple blade saw without any personnel being involved.

This is illustrated in FIG. 2, which provides an overview of a fully automatic handling station for wood processing.

The first robot (on the right in FIG. 2), which is arranged upstream of the sawing apparatus, is able by means of a special gripper to identify trimmed or untrimmed boards on a stack of unprocessed wood that has been provided, to detect the curvature of the edge, and to carry out the alignment process on the basis of the determined values along the zero line of the sawing apparatus (for example a multiple blade circular saw). Possible alternatives have been described above.

The identification of the edge and of the curvature of the item to be sawn (for example a board) is in this case carried out as described above using two or more laser rangefinders A, B, C, D, with the sequence and the contact time with the upper edge of the respective board being used to calculate the curvature. For this purpose, the gripper is made to approach from the side of the board (symbolized by arrows pointing to the left in FIG. 1) once it has subsequently been aligned with the zero line of the sawing apparatus.

According to one alternative, the item to be sawn is then positioned in front of the sawing apparatus by rotation of the gripper, such that the timber edge, or the curved edge of already trimmed boards, is cut off with minimal loss. This is shown in detail as the view X in FIG. 2. The detailed view shows the gripper with the laser rangefinders and the zero line of the item to be sawn. This is the zero line which is then aligned with the zero line of the saw blade, after being lifted off the stack of unprocessed wood.

The item to be sawn is then transported to the sawing apparatus by means of a transport system which draws it in. If there are stacking strips between the individual board layers, these are likewise automatically removed by the first robot by means of brushes. The brushes are integrated in the grippers of the robot.

The entire procedure is carried out without any human intervention and without previously removing the boards from the stack and separating them. The alignment accuracy that is achieved is approximately 0.5 mm.

A second robot, which is shown on the left in FIG. 2, is arranged behind the sawing apparatus. This second robot is intended to remove the cut strips and, for example, to feed them to different stacking positions depending on their width. Light probes which are arranged on the output side of the sawing apparatus detect the width and the number of cut strips.

The edging (that is to say the timber edge) is disposed of independently of the robot via a measurement system which is integrated in the sawing apparatus.

If the cut width of the strips corresponds to a predetermined criterion, then the strips are automatically transferred to the next production step for further processing. Strips which are relatively narrow but are still more than a minimum width are stacked separately, and could be processed further in some other way.

Strips whose width is less than the minimum width, the timber edge and/or the sawing residue from curved boards slide over a collapsible table directly into the feed for automatic shears. However, if the remaining item to be sawn is broader than the sawing range of the automatic shears, then the second robot moves this remaining piece automatically to a conveyor belt in the opposite direction, which transports it to a defined position in front of the sawing apparatus, where a sensor signals the arrival of the remaining piece. It is then once again fed to the sawing apparatus, in which case this process can be repeated until the entire board has been cut up.

In order to improve the control, the robots can be controlled by means of a speech recognition system. An operator can thus instruct the second robot to place a cut strip on a stack of quality A or B. He can also instruct the second robot to pass strips of a specific width to a subsequent machine. It is also possible for him to be able to give instructions that a remaining piece (a board cannot be sawn up in one sawing process) should be placed on a conveyor belt in the opposite direction.

The embodiment of the invention is not restricted to the preferred exemplary embodiments specified above. In fact, a number of variants are feasible, which also make use of the handling apparatus for items to be sawn according to the invention in fundamentally different ways.

1. A handling apparatus for items to be sawn, in particular for feeding a multiple blade circular saw, having at least one robot for automatic three-dimensional alignment of at least one item to be sawn, in particular a board, with respect to a sawing apparatus,
characterized
in that the zero line of the item to be sawn can be determined automatically even in an unprocessed wood stack by means of the at least one robot.

2. The handling apparatus for items to be sawn as claimed in claim 1, characterized in that the zero line of the at least one item to be sawn can be aligned automatically with the zero line of a circular saw blade.

3. The handling apparatus for items to be sawn as claimed in claim 1 or 2, characterized by means for automatic detection of three-dimensional curvature and/or unevennesses of at least one item to be sawn.

4. The handling apparatus for items to be sawn as claimed in claim. 3, characterized in that the means for automatic detection of three-dimensional curvature of the at least one item to be sawn has an apparatus for distance measurement and/or a light barrier.

5. The handling apparatus for items to be sawn as claimed in claim 4, characterized in that the apparatus for distance measurement has at least one laser rangefinder and/or one light barrier.

6. The handling apparatus for items to be sawn as claimed in claim 5, characterized in that the laser rangefinder can be used to measure a horizontal and/or vertical distance to one edge of the item
to be sawn.

7. The handling apparatus for items to be sawn as claimed in at least one of claims 3 to 6, characterized in that more than two apparatuses for distance measurement scan a timber edge of the item to be sawn.

8. The handling apparatus for items to be sawn as claimed in at least one of claims 4 to 7, characterized in that at least one apparatus for distance measurement has at least one camera and/or at least one laser scanner.

9. The handling apparatus for items to be sawn as claimed in claim 8, characterized in that the camera and/or the scanner are/is arranged above the item to be sawn such that they or it can be moved, in particular automatically, with respect to the item to be sawn.

10. The handling apparatus for items to be sawn as claimed in claim 8 or 9, characterized in that the board curvature and/or the zero line of the item to be sawn are/is calculated by a data processing apparatus which is coupled to the camera.

11. The handling apparatus for items to be sawn as claimed in at least one of claims 8 to 10, characterized in that the laser scanner is arranged such that its light lines run transversely with respect to the longitudinal extent direction of the item to be sawn.

12. The handling apparatus for items to be sawn as claimed in claim 11, characterized in that the board curvature and/or the zero line of the item to be sawn are/is calculated after scanning the light lines by means of the camera.

13. The handling apparatus for items to be sawn as claimed in at least one of claims 10 to 12, characterized in that the data which is calculated in the data processing apparatus is stored in a memory such that it can be called up.

14. The handling apparatus for items to be sawn as claimed in at least one of the preceding claims, characterized by an alignment means, using which at least one item to be sawn is aligned with respect to the zero line of a saw blade as a function of a measured curvature of the item to be sawn.

15. The handling apparatus for items to be sawn as claimed in at least one of the preceding claims, characterized in that the at least one item to be sawn is aligned automatically with respect to a saw blade so as to produce minimum sawing residue.

16. The handling apparatus for items to be sawn as claimed in at least one of the preceding claims, characterized in that a robot having a gripper is used for automatically controlled movement, in particular alignment with respect to the sawing apparatus of the at least one item to be sawn.

17. The handling apparatus for items to be sawn as claimed in at least one of claims 13 to 16, characterized in that the robot positions the gripper as a function of the data which is stored in the memory.

18. The handling apparatus for items to be sawn as claimed in at least one of the preceding claims, characterized in that the at least one item to be sawn is held, transported and/or aligned by means of a vacuum sucker.

19. The handling apparatus for items to be sawn as claimed in at least one of the preceding claims, characterized in that a second robot is arranged after the sawing apparatus and sorts the
sawn material as a function of a predetermined criterion, in particular the width.

20. The handling apparatus for items to be sawn as claimed in at least one of the preceding claims, characterized in that the first and/or the second robot has/have a means for speech control.
